(19) United States
(12) Patent Application Publication
(10) Pub. No.: US 2026/0226235 A1
(43) Pub. Date: Aug. 6, 2026

(54) ALKOXYLATED POLYALKYLENEIMINES, PREPARATION AND USE

(71) Applicants: BASF SE, Ludwigshafen am Rhein (DE); THE UNIVERSITY OF NOTTINGHAM, Nottingham (GB)

(72) Inventors: Stephan HUEFFER, Ludwigshafen am Rhein (DE); Ivette GARCIA CASTRO, Ludwigshafen am Rhein (DE); Tobias Maximilian MERKEL, Ludwigshafen am Rhein (DE); Lee Anthony STEVENS, Nottingham (GB); Colin Edward SNAPE, Nottingham (GB)

(21) Appl. No.: 19/119,195

(22) PCT Filed: Oct. 19, 2023
(86) PCT No.: PCT/EP23/79123

§ 371 Date: Apr. 8, 2025

(30) Foreign Application Priority Data
Nov. 14, 2022 (EP) 22207176.3

(51) Int. Cl. C08G 73/02; B01D 53/14; B01D 53/62; B01D 53/78

(52) U.S. Cl. CPC C08G 73/0206; B01D 53/1475; B01D 53/1493; B01D 53/62; B01D 53/78; B01D 2252/20415; B01D 2257/504; B01D 2258/0283; B01D 2258/06

(57) ABSTRACT

Disclosed herein is a method of using a composition including alkoxylated Polyalkyleneimine, the method including using the composition for capturing gases with a pKa greater than 5, from a gas or mixture of gases, the composition being obtained by a process for producing a composition including an alkoxylated polyalkyleneimine including the steps:
(a) providing a reaction mixture including
   (i) a polyalkyleneimine; and
   (ii) an alkylene oxide;
(b) carrying out a reaction between the (i) polyalkyleneimine and the (ii) alkylene oxide at a temperature of at least 50° C.; and
(c) optionally diluting the product of step (b),
   where the mole ratio of alkylene oxide to NH of the polyalkyleneimine in the reaction mixture is from 0.1 to 0.35.

Also described herein is a composition including an alkoxylated polyalkyleneimine, which is obtainable by the process.

### FIELD OF THE INVENTION

The present invention is in the field of alkoxylated polyalkyleneimines used for capturing a gas of pKa, greater than 5, particularly carbon dioxide, from a gas or gases containing it. The invention also provides new compositions of alkoxylated polyalkyleneimines and provides a novel process preparing the compositions. The new compositions have been found to be particularly effective for absorbing carbon dioxide. The process also has the advantage of avoiding the use of volatile organic compounds, specifically polar organic solvents.

### BACKGROUND OF THE INVENTION

The increasing levels of greenhouse gases in the atmosphere is of growing global concern in view of the predicted impact on climate change. This is particularly so in view of the rising levels of carbon dioxide. It is widely accepted that even the present concentration of carbon dioxide in atmospheric air is responsible for increasing dramatic environmental changes, including droughts, flooding and disruption of ecosystems around the world. It is predicted that as carbon dioxide levels continue to rise that we are predicted see significant increases in the average temperatures of the atmosphere and oceans leading to increasing melting of polar and glacier ice which in turn would bring about rising sea levels with the inevitable flooding of low-lying lands. Increased atmospheric temperatures are also expected to increase the likelihood of powerful cyclonic storms globally.

The governments of many countries are aiming to act by legislating with the aim of reducing emissions of greenhouse gases, particularly carbon dioxide, and ultimately limit global warming. Many nations have adopted The Paris Agreement which is a legally binding international treaty on climate change. Its goal is to limit global warming to well below 2, preferably to 1.5° C., compared to preindustrial levels.

In recent years there has been a great deal of effort placed in developing technologies that can achieve the goal of reducing carbon dioxide levels from atmospheric air and/or gaseous emissions. Capturing carbon dioxide at source is generally regarded as the most cost-effective. Typically, this could be large carbon-based energy facilities, natural gas processing, synthetic fuel plants, industries with major carbon dioxide emissions, for instance steelmaking and cement production, and hydrogen production plants which employ fossil fuels.

One dominant carbon capture technology involves absorption or sequestering of the carbon dioxide. By far the most common active compounds used for absorbing carbon dioxide has relied on amine chemistry. Typical amines used for this purpose include alkanolamines, including monoethanolamine, diethanolamine, diisopropanolamine, pentaethylenehexamine, tetraethylenepentamine, triethylenetetramine, tetraethylenetetramine, bis(2-hydroxypropyl) amine, N,N′-bis (2-hydroxy ethyl)ethylene diamine, alkyl amines, methyl amine, linear polyethyleneimine, branched polyethyleneimine, dimethyl amine, diethyl amine, methyl diethanolamine, methyl ethanol amine, polyethylene polyamine, diethylene tri-amine, N,N′-bis-(3-aminopropyl)ethylene diamine.

U.S. Pat. No. 9,084,960 B2 discloses a method for reducing the CO₂ content of a gas and employs CO₂ capture agents that may include mono amines (in particular secondary amines, such as diethanolamine), polyamines, monoguanidines and polyguanidines and mixtures of these compounds.

U.S. Pat. No. 9,533,250 B2 concerns CO₂ reduction from indoor air from an enclosed space. The reference describes an amine-based compound, and it is suggested that the amine-based compound may comprise any suitable amine, such as a primary or secondary coming, or a combination thereof. The disclosure reveals that the amine-based compound may range from simple single molecules, such as ethanolamine, to large molecule amine polymers such as polyethyleneimine. Suggested in the document are monoethanolamine, ethanol amine, methylamine, branched polyethyleneimine, linear polyethyleneimine, diethanolamine, dimethylamine, diethylamine, diisopropanolamine, tetraethylenepentamine, methyldiethanolamine, methylethanolamine, and any of several polyamines such as polyethyleneimine, or a combination thereof.

U.S. Pat. No. 11,229,897 B2 discloses a gas absorbing material that includes a polyamine produced using a process that is free of formaldehyde as a reaction product and/or a reactant. The disclosure describes producing reaction solution of a first amine compound and a reactant. The reactant is said to comprise a carbonate ester compound or a ketone compound. The first amine compound would react with the reactant to produce a second amine compound.

U.S. Pat. No. 10,010,861 B2 describes a polymeric amine in the context of absorbing carbon dioxide. The polymeric amine is said to consist of a polymer skeleton containing nitrogen atoms and branched chains bonded to the nitrogen atoms of the polymer skeleton. Each of the branched chains contains at least one nitrogen and the polymeric amine is modified by substitution of at least one of the nitrogen atoms of the polymer skeleton or the branched chains with a hydroxyl group containing carbon chain. Example 1 describes the synthesis of polyethyleneimines modified by a partial substitution with butylene oxide. This synthesis involves dissolving a polyethyleneimine (MN=1200, 19 mmol N/g) in methanol. The disclosure reveals adding the butylene oxide to the polyethyleneimine/methanol solution in different amounts such that the mole ratio of the butylene oxide to nitrogen atoms present in the polyethyleneimine were 0.15:1, 0.37:1, and 0.54:1. The disclosure reveals removing the solvent by subjecting the solutions of the modified polyethyleneimine to heating in a vacuum oven.

U.S. Pat. No. 10,751,689 B2 discloses a modified polyamine in the context of absorbing carbon dioxide. The modified polyamine is the reaction product of an amine and an epoxide. Example 1 reveals preparing a modified polyamine species based on pentaethylenehexamine (PEHA) and propylene oxide (PO). The preparation describes dissolving 10 g of the PEHA in 40 ml of water and adding 5 g of PO to the PEHA solution followed by stirring for 20 hours at room temperature. The temperature of the reaction mixture was said to be raised progressively to 60° C. which was maintained for two hours. The water was said to be removed by rotary evaporator followed by overnight vacuum at below 1 mmHg.

Alkoxylation of polyalkyleneimines is well known and documented in the literature. For instance, alkoxylation of polyethyleneimines using ethylene oxide, propylene oxide and butylene oxide is described in Houben-Weyl, Methoden der organischen Chemie, 4. Ed., Vol. 14/2, p. 440 ff. (1963) and Vol. E 20, p. 1367 f. (1987).

US Published US2021309934 A1 relates to a process for manufacturing ethoxylated polyethyleneimines by reacting at least one polyethyleneimine (PEI) with at least one ethylene oxide EO. In a first step (1), the polyethyleneimine (PEI) is reacted with ethylene oxide EO in a quantity of less than one molar equivalent per PEI, and subsequently, in a second step (2), the product of step (1) is reacted with a further quantity of ethylene oxide EO, in the presence of a basic catalyst. The ethylene oxide EO is said to be added in step (1) in an amount of 0.01 to 0.85 ethylene oxide units per NH-group of the polyethyleneimine (PEI). The polyethyleneimine (PEI) is said to have a molecular weight Mw (prior to ethoxylation) in the range of 1000 to 5000. This document seems to address the problem that the inclusion of ethoxylated polyethyleneimines prepared by known processes into laundry formulations can reduce the viscosity of the resulting liquid, which leads to reduced consumer acceptability in the formulation and requiring additional viscosity boosting technology. It is indicated that the use of the two-step process for ethoxylation of the initial PEI and adjusting the amount of EO added in the first (and second) step to a certain range (strong under-hydroxyethylation), the problems of the prior art can be significantly weakened.

The inventors of the present invention set out with the objective of providing an alkoxylated polyethyleneimine with improved activity for capturing carbon dioxide by comparison to state-of-the-art conventional alkoxylated polyethyleneimines used for this purpose. A further objective of the present invention is to provide a convenient method for providing alkoxylated polyethyleneimines suitable for capturing carbon dioxide and preferably with improved activity for this purpose.

### SUMMARY OF THE INVENTION

In accordance with the first aspect of the present invention we provide the use of a composition comprising alkoxylated polyalkyleneimine, preferably an alkoxylated polyethyleneimine, for capturing gases with a pKa greater than 5, preferably carbon dioxide, from a gas or mixture of gases, the composition being obtainable by a process comprising the steps:
(a) providing a reaction mixture comprising
   (i) a polyalkyleneimine, preferably a polyethyleneimine; and
   (ii) an alkylene oxide;
(b) carrying out a reaction between the (i) polyalkyleneimine, preferably polyethyleneimine, and the (ii) alkylene oxide at a temperature of at least 50° C.; and
(c) optionally diluting product of step (b),
   wherein the mole ratio of alkylene oxide to NH-units of the polyalkyleneimine, polyethyleneimine, in the reaction mixture is from 0.1 to 0.35,
   and wherein the reaction mixture comprises <55% water, preferably <30% water, by weight based on the weight of the reaction mixture and the reaction mixture comprises less than 5%, preferably less than 1%, of polar organic solvent, by weight based on the weight of the reaction mixture.

NH represents the amine number and is calculated by determination of the secondary amino groups and primary amino groups, where NH=(number of secondary amino groups)+(2×(number of primary amino groups)). NH is determined by titration of the respective polyalkyleneimine with trifluoromethansulphonic acid.

A second aspect of the present invention concerns a process of preparing a composition comprising an alkoxylated polyalkyleneimine, preferably an alkoxylated polyethyleneimine, obtainable by a process comprising the steps:
(a) providing a reaction mixture comprising
   (i) a polyalkyleneimine, preferably polyethyleneimine; and
   (ii) an alkylene oxide, the alkylene oxide comprising propylene oxide and/or butylene oxide;
   (b) carrying out a reaction between the (i) polyalkyleneimine, preferably polyethyleneimine, and the (ii) alkylene oxide at a temperature of at least 50° C.,
   (c) optionally diluting product of step (b),
      wherein the mole ratio of alkylene oxide to NH-units of the polyalkyleneimine, preferably polyethyleneimine, in the reaction mixture is from 0.1 to 0.35,
      and wherein the reaction mixture comprises <55% water, preferably <30% water, by weight based on the weight of the reaction mixture and the reaction mixture comprises less than 5%, preferably less than 1%, of polar organic solvent, by weight based on the weight of the reaction mixture.

A third aspect of the present invention provides a composition comprising an alkoxylated polyalkyleneimine, preferably an alkoxylated polyethyleneimine, the alkoxylated polyalkyleneimine, preferably alkoxylated polyethyleneimine, composition is obtainable by a process comprising the steps:
(a) providing a reaction mixture comprising
   (i) a polyalkyleneimine, preferably polyethyleneimine; and
   (ii) an alkylene oxide, the alkylene oxide comprising propylene oxide and/or butylene oxide;
(b) carrying out a reaction between the (i) polyalkyleneimine, preferably polyethyleneimine, and the (ii) alkylene oxide at a temperature of at least 50° C.,
(c) optionally diluting product of step (b),
   wherein the mole ratio of alkylene oxide to NH-units of the polyalkyleneimine, preferably polyethyleneimine, in the reaction mixture is from 0.1 to 0.35,
   and wherein the reaction mixture comprises <55% water, preferably <30% water, by weight based on the weight of the reaction mixture and the reaction mixture comprises less than 5%, preferably less than 1%, of polar organic solvent, by weight based on the weight of the reaction mixture.

### DETAILED DESCRIPTION OF THE INVENTION

The inventors of the present invention found the alkoxylated polyalkyleneimine, particularly the alkoxylated polyethyleneimine, provided by the newly developed process unexpectedly exhibited particularly improved results for capturing carbon dioxide, by comparison to state-of-the-art alkoxylated polyalkyleneimines.

Without being limited to theory, the inventors believe that by carrying out the process with no or virtually no polar organic solvent (i.e. less than 5%, preferably less than 1%) with no or limited amount of water present (i.e. <55% water, preferably <30% water based on the weight of the reaction mixture) that competing side reactions are avoided by comparison to processes of alkoxylation of polyalkyleneimines using higher levels of solvent. Indeed, at the low ratio of alkylene oxide to NH such competing reactions which could prevent alkoxylation are prevented in order to ensure that alkoxylation at the desired ratio is at least substantially fully achieved.

The process is considered to be much more suitable for a commercial scale production of alkoxylated polyethyleneimine having the low ratio of alkylene oxide to NH. The inventors realised that this in combination of no or virtually no organic solvent and no or limited presence of water with the narrow weight ratio of alkylene oxide to NH of the polyalkyleneimine of 0.1 to 0.35 provides an alkoxylated polyalkyleneimine more effective for the purpose of absorbing carbon dioxide. This could not have been deduced or predicted by the person skilled in the art.

It is desirable that the reaction mixture in the process comprises suitably less than 3%, often less than 2%, preferably less than 1%, such as less than 7500 ppm, more preferably less than 5000 ppm, especially preferably less than 1000 ppm, less than 500 ppm, more especially preferred less than 100 ppm, particularly preferred less than 50 ppm polar organic solvent, by weight based on the weight of the reaction mixture. Most preferably the reaction mixture is free from any polar organic solvent. The inventors believe that avoiding polar organic solvent completely most effectively avoids the risk of unwanted competing side reactions and will provide a more effective product. Further, the inventors unexpectedly found that the reaction rate was greater when carried out in the absence of polar organic solvent. Such increased reaction rates would be beneficial to production time and costs and may be especially useful when considering a continuous process. In addition, the inventors have found that by avoiding the inclusion of polar organic solvent in the reaction mixture that less residual alkylene oxide remains in the reaction product. Achieving low levels of alkylene oxide in the alkoxylated polyalkyleneimine is important to the product safety in view of the high toxicity of alkylene oxide.

By polar organic solvent we mean organic compounds exhibiting polarity typically used as solvents. Typically, such organic solvents would be organic liquids that dissolve or are miscible with polyalkyleneimines or alkoxylated polyalkyleneimines. Specific examples of such polar organic solvents include methanol, ethanol, isopropanol, acetone, DMF, and chloroform.

Thus, the composition comprising alkoxylated polyalkyleneimine, preferably alkoxylated polyethyleneimine, produced according to the present invention preferably contains less than 150 ppm, suitably less than 100 ppm, more suitably less than 50 ppm, more preferably less than 20 ppm, especially preferably less than 10 ppm, more especially preferably less than 5 ppm residual alkylene oxide, by weight on the weight of alkoxylated polyalkyleneimine in the composition.

These concentrations of alkylene oxide may be determined by thermal desorption with the volatiles released quantified by gas chromatography-mass spectrometry. The GC/MS used to calculate values according to the present disclosure was provided by Agilent. The system configuration was GC-MS Kopplung (7890/5975 or 7890/5977) with an Electron lonisation ion source and a single quadruple spectrometer.

The alkoxylated polyalkyleneimine, preferably alkoxylated polyethyleneimine, according to the present invention is obtainable by a process in which the amount of water in the reaction mixture must be less than 55% by weight based on the weight of the reaction mixture. Desirably the amount of water in the reaction mixture should be less than 50%, normally less than 40%, typically up to 36% or up to 35% by weight of the reaction mixture but usually less than 35% by weight of the reaction mixture. Preferably the amount of water in the reaction mixture should be less than 30% by weight of the reaction mixture. Desirably the amount of water should be less than 20% by weight of the reaction mixture. It is more desirable that the amount of water in the reaction mixture should be lower still, for instance up to 17% by weight of the reaction mixture, typically up to 16% by weight of the reaction mixture, such as up to 15% by weight of the reaction mixture, but often less than 15%, preferably up to 13%, or up to 12%, often less than 12%, more preferably up to 11%, or up to 10%, usually less than 10%, for instance less than 5% by weight based on the weight of the reaction mixture. More preferably still the amount of water present in the reaction mixture should be less than 2%, especially less than 1% by weight based on the weight of the reaction mixture. Especially preferably the reaction mixture should contain no water.

In one desirable embodiment, the reaction mixture is solvent free and contains water in an amount only as a reactant, suitably up to 1 mole of water per mole of NH groups of the polyalkyleneimine, preferably polyethyleneimine. By this we mean that the amount of water present in the reaction mixture as a reactant is present in an amount of one mole of water per mole of NH groups on the polyalkyleneimine, preferably polyethyleneimine, to be alkoxylated.

The process of producing the alkoxylated polyalkyleneimine, preferably alkoxylated polyethyleneimine, may be continuous, batch, semi-batch or fed batch. Preferably the process is fed batch and/or continuous. Desirably the fed batch process would involve one or more of the reactants (first reactant(s)) being placed in the reaction vessel while a further reactant or reactants (second reactant(s)) is fed into the reaction vessel at a defined rate and mixed with the first reactant to form the reaction mixture while the reaction proceeds.

In a desirable embodiment, steps (a) and (b) of the process may be carried out partially, mostly or wholly simultaneously.

In one embodiment in step (a) of the process the (i) polyalkyleneimine, preferably polyethyleneimine, is provided, suitably in a reaction vessel. Preferably the polyalkyleneimine, preferably the polyethyleneimine, would be provided at a temperature of at least 50° C. Suitably the temperature of the polyalkyleneimine, preferably polyethyleneimine, may be provided at temperature from 50° C. to 150° C., preferably from 60° C. to 140° C., more preferably from 60° C. to 110° C. Desirably the (ii) alkylene oxide would be provided at a temperature of at least 50° C., suitably from 50° C. to 110° C., preferably from 60° C. to 100° C., and combined with the (i) polyalkyleneimine, preferably polyethyleneimine, to form the reaction mixture.

Preferably the (ii) alkylene oxide would be combined with the (i) polyalkyleneimine, preferably polyethyleneimine, by feeding it into the (i) polyalkyleneimine, preferably polyethyleneimine, at a defined rate forming the reaction mixture. As the (ii) alkylene oxide is fed into the (i) polyalkyleneimine, preferably polyethyleneimine, the reaction (b) may commence. Thus, the reaction in this embodiment would commence and proceed as the alkylene oxide is being fed into the reaction mixture.

The reaction in step (b) would desirably be commenced by raising the temperature of the reaction mixture. Suitably the reaction in step (b) may be carried out at a temperature of at least 60° C., more suitably from 60° C. to 140° C., preferably from 75° C. to 135° C., more preferably from 80° C. to 130° C., still more preferably from 80° C. to 130° C.

Preferably the reaction in step (b) may be carried out at an elevated pressure, for instance greater than 1 bar, suitably in a pressurised reaction vessel. Preferably the reaction may be carried out at a pressure greater than 1.25 bar, preferably at a pressure of from 1.5 bar to 3 bar.

It may be desirable to provide the composition comprising the alkoxylated polyalkyleneimine, preferably alkoxylated polyethyleneimine, in a diluted form. Thus, in this respect following the reaction step (b) the composition comprising the so formed reaction product may be diluted with water in the dilution step (c). In the preferred embodiment where the reaction step (b) is carried out at an elevated pressure as indicated above the dilution step (c) should be carried out after the reaction mixture in the reaction vessel has been depressurised. Desirably the product of reaction step (b) may be diluted with water to provide an aqueous solution of the alkoxylated polyalkyleneimine, preferably alkoxylated polyethyleneimine, at a concentration of from 50% to 70% by weight of alkoxylated polyalkyleneimine, preferably alkoxylated polyethyleneimine, on the weight of the aqueous solution.

In the process the mole ratio of alkylene oxide to NH of the polyalkyleneimine, preferably polyethyleneimine, is from 0.1 to 0.35. Preferably the mole ratio of alkylene oxide to NH is from 0.15 to 0.32. As stated above, NH represents the amine number and is calculated by determination of the secondary amino groups and primary amino groups, where NH=(number of secondary amino groups)+(2×(number of primary amino groups)). NH is determined by titration of the respective polyalkyleneimine with trifluoromethansulphonic acid.

The (i) alkylene oxide may be any suitable alkylene oxide for the alkoxylation of the polyalkyleneimine, preferably polyethyleneimine. The reference to alkylene oxide, for instance propylene oxide or butylene oxide, used throughout this specification, unless otherwise stated, refers to the 1,2-epoxy substituted compound. It has been found that the (i) alkylene oxides that contain at least three carbon atoms are particularly suitable in the application of capturing gases with a pKa of greater than 5, preferably carbon dioxide. In one desirable embodiment of the alkylene oxide may be one or mixtures of more than one C₃-C₁₂-alkylene oxide, desirably a C₃-C₁₀-alkylene oxide, more desirably a C₃-C₈-alkylene oxide, preferably propylene oxide and/or butylene oxide. It is preferred that the alkylene oxide comprises propylene oxide and/or butylene oxide. Thus, the alkylene oxide may be propylene oxide or it may be butylene oxide or it may be a mixture of propylene oxide and butylene oxide or the alkylene oxide in comprising propylene oxide and/or butylene oxide may contain a mixture of either or both of propylene oxide and butylene oxide with higher alkylene oxides. In one desirable embodiment the alkylene oxide is a mixture of alkylene oxides comprising a mixture of C₃-C₄ alkylene oxides, i.e. propylene oxide or butylene oxide, and C₈-C₁₂ alkylene oxides, preferably having a molar ratio of C₃-C₄ alkylene oxides to C₈-C₁₂ of from 2:1 to 20:1, 3:1 to 15:1, 4:1 to 12:1, more preferably from 5:1 to 10:1 or 5:1 to 9:1. Particularly preferred mixtures of alkylene oxides include propylene oxide with any of 1-octene oxide, 1-decene oxide or 1-dodecene oxide, suitably within any of the aforementioned ranges of ratios; or butylene oxide with any of 1-octene oxide, 1-decene oxide or 1-dodecene oxide, suitably within any of the aforementioned ranges of ratios.

The alkoxylated polyalkyleneimine comprised in the composition of the present invention or prepared according to the inventive process may be linear or branched. In particular, for the branched polyalkyleneimine, branching may occur at its nitrogen fractions. The linear polyalkyleneimines are composed exclusively of repeat units of formula A; the branched polyalkyleneimines have, besides the linear repeat units, tertiary nitrogen atoms according to the formula B.

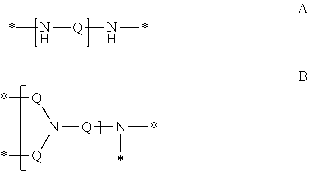

In which Q may be C₂-C₈ alkylene, suitably is ethylene, propylene or butylene and preferably is ethylene.

Preference is given to polyalkyleneimines, especially polyethyleneimines, having a degree of branching (DB) of more than 50 are preferably more than 60. Polyalkyleneimines, including polyethyleneimines, can be characterised by their degree of branching (DB). To define the degree of branching, reference is made to H. Frey et al., Acata Polym. 1997, 48, 30. The degree of branching DB is defined therein as

$$DB ( \% ) = ( T + Z ) / ( T + Z + L ) \times 100 ,$$

where
T is the average number of terminally bound monomeric units (primary amino groups),
Z is the average number of branching monomeric units (tertiary amino groups), L is the average number of linearly bound monomeric units (secondary amino groups). T, Z, and L can be determined via 13C-NMR in D₂O. Reference is made to T. St Pierre & M. Geckle (1985) ¹³C-NMR Analysis of Branched Polyethyleneimine, Journal of Macromolecular Science: Part A-Chemistry, 22:5-7, 877-887, DOI: 10.1080/00222338508056641.

The degree of branching DB of the polyalkyleneimines, especially polyethyleneimines, according to the present invention is preferably in the range of 55 to 95%, preferably in the range from 57 to 90% and more preferably in the range from 60 to 80%.

The polyalkyleneimine, preferably polyethyleneimine, employed in the reaction mixture may desirably have a weight average molecular weight (MW) or from 300 to 20,000, for instance from 300 to 15,000, suitably from 300 to 10,000, more suitably from 300 to 5000, preferably from 500 to 1500, more preferably from 500 to 1000 g/mol.

The polyalkyleneimine suitable for forming the alkoxylated polyalkyleneimine can be made by various methods understood in the art. For example, polyethyleneimine can be made by a ring opening of aziridine by acid catalysed polymerisation.

In various desirable embodiments, the polyethyleneimine is preferably a branched polymer comprising groups such as represented by formulae C and D:

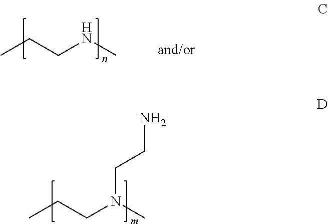

wherein n or m are typically about 7 to about 500 such that the polyethyleneimine has a weight average molecular weight (Mw) from about 300 to about 20,000 about for instance from 300 to 15,000, suitably from 300 to 10,000, more suitably from 300 to 5000, preferably from 500 to 1500, more preferably from 500 to 1000 g/mol. It is also contemplated that the polyethyleneimine may have any value or range of values, both whole and fractional, within those ranges described above.

Preferably, the alkoxylated polyethyleneimine is derived from a branched polyethyleneimine. The polyethyleneimine is a branched polymer having the following exemplary structure:

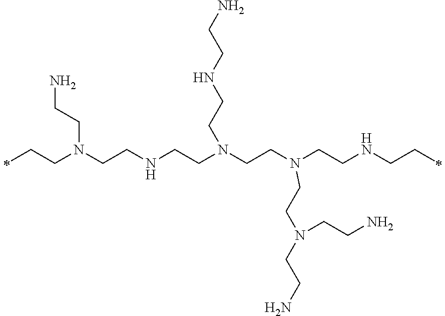

Still referring to the exemplary structure above, the branched structure of the polyethyleneimine provides primary, secondary, and tertiary amines. That is, the polyethyleneimine typically includes linear (L), dendric (D), and terminal groups (T). The * in the above exemplary structure represents the rest of the polyethyleneimine molecule.

In some embodiments, the branched polyethylene imine comprises: from about 20 to about 55, or from about 30 to about 45, percent linear groups (L); from about 10 to about 40, or from about 20 to about 30, dendric groups (D); and from about 20 to about 55, or from about 30 to about 45, percent terminal groups (T), based on 100 percent of all groups present in said branched polyethylene imine as determined via ¹³C-NMR in D₂O. In additional non-limiting embodiments, all values and ranges of values, both whole and fractional, within one or more of the aforementioned ranges, are hereby expressly contemplated.

Suitable alkoxylated polyethyleneimine can be derived from polyethyleneimine commercially available from BASF under the tradename of LUPASOL®.

In one particularly preferred form of the present invention, the alkoxylated polyalkyleneimine, preferably alkoxylated polyethyleneimine, is derived from a branched polyalkyleneimine, preferably branched polyethyleneimine, having a weight average molecular weight (Mw) from 500 to 10,000 g/mol and the alkoxylation is provided from any of ethylene oxide, propylene oxide or butylene oxide, especially preferably propylene oxide or butylene oxide and most preferably propylene oxide.

The alkoxylated polyalkyleneimine, preferably alkoxylated polyethyleneimine, desirably has a OH/NH molar ratio of from 0.20 to 0.35. The OH/NH ratio can be determined using ¹³C NMR.

The composition comprising the alkoxylated alkyleneimine, preferably alkoxylated polyethyleneimine, according to the third aspect of the present invention especially preferably comprises <10 ppm, more especially preferably <5 ppm alkylene oxide, by weight on the weight of alkoxylated polyalkyleneimine in the composition. These concentrations may be determined by thermal desorption with the volatiles released quantified by gas chromatography-mass spectrometry. The GC/MS used to calculate values according to the present disclosure was provided by Agilent. The system configuration was GC-MS Kopplung (7890/5975 or 7890/5977) with an Electron Ionisation ion source and a single quadruple spectrometer.

The inventors have found that the composition comprising the alkoxylated polyalkyleneimine, preferably alkoxylated polyethyleneimine, obtainable by the aforementioned process, including any of its preferred embodiments for capturing a gas with a pKa greater than 5. Preferably the said gas would be carbon dioxide. According to the inventive use the gas with a pka greater than 5, preferably carbon dioxide, would be captured from a gas or mixture of gases.

In one preferred embodiment of this inventive use, the alkoxylated polyalkyleneimine, preferably alkoxylated polyethyleneimine, may be employed directly, used as an aqueous solution or incorporated into a liquid formulation.

Further, once the alkoxylated polyalkyleneimine in the composition has become fully charged with the gas of pKa greater than 5, e.g. carbon dioxide, the composition can be subjected to a desorption step. The desorption step may suitably be performed by heating such that the gas, e.g. carbon dioxide, is released in the process where the gas, such as carbon dioxide, and then stored more permanently in a controlled environment. The desorption of the gas, such as carbon dioxide, is well documented and known in the art. This absorption/desorption of the gas, such as carbon dioxide, is referred to as an absorption/desorption cycle.

The inventors have found that the composition containing the alkoxylated polyalkyleneimine is able to absorb the carbon dioxide more quickly. This is irrespective of whether the composition is a liquid composition, e.g. an aqueous solution containing the alkoxylated polyalkyleneimine, or contained as part of a solid article or product. Thus, the composition containing the alkoxylated polyalkyleneimine is able to reach full capacity, i.e. fully charged with CO₂, in a shorter time span, typically with a reduction in time of up to 80% or more than conventional alkoxylated polyalkyleneimines prepared by conventional routes. This means that the overall time period for the absorption/desorption cycle can be reduced and the number of absorption/desorption cycles can be increased by at least 200%. This can have a benefit of reducing capital expenditure and process costs.

The increase in rotational speed (i.e. absorption/desorption cycles) importantly results from the increase in the uptake/absorption velocity and the desorption velocity.

More preferably the gas or mixture of gases is either atmospheric air or any sort of exhaust fumes. Typically, the exhaust fumes may for instance be gases emitted from an industrial process, including power generating plants, typically produced from combustion of carbonaceous material. Additionally, the exhaust fumes may be produced from various other devices such as heat generating devices, including commercial and domestic boilers, or other devices such a motion generating devices, for instance combustion engines for vehicles. The capturing of carbon dioxide from air typically means any air in the atmosphere I can also include air in enclosed spaces, for instance buildings.

The following examples are intended to illustrate instant invention and are not to be viewed in any way as limiting the scope of the present invention.

### EXAMPLES

### Comparative Examples 1-3

### Comparative Example 1

A 2 L glass flask with stirrer and a refluxing funnel was charged with 465 g polyethylenimine (PEI, Mw 800 g/mol, amine number 18.2 mmol/g) and 500 g methanol was added (300 rpm) while nitrogen was purged for 20 minutes while the mixture heated to 30° C. The temperature was kept within 30-35° C., 147.3 g propylene oxide (PO) was dosed over a period of 3 h. The mixture was stirred and mildly refluxed at 40° C. overnight. Then the methanol was removed within 45 minutes. Finally, the temperature was raised to 80° C. for another 45 Minutes and then 40 mbar of vacuum was applied for 15 minutes. The obtained yellowish mixture was quenched with nitrogen and cooled to room temperature (approximately 20° C.) and 615 g of a yellowish viscous liquid was obtained.

### Comparative Example 2

A 2 L glass flask with stirrer and a refluxing funnel was charged with 470 g polyethylenimine (PEI, Mw 1200 g/mol, amine number 17.9 mmol/g). 115 g water and 500 g methanol were added (300 rpm) and nitrogen was purged 20 minutes while the mixture was heated to 30° C. While the temperature was kept within 30-35° C., 151.5 g butylene oxide (BuO) was dosed over a period of 3 h. The mixture was stirred and mildly refluxed at 40° C. overnight. Then the methanol and water were removed while the temperature was raised to 100° C. (90 minutes) and kept for 45 minutes at 100° C. and then 40 mbar of vacuum was applied for 30 minutes. The obtained yellowish mixture was quenched with nitrogen and cooled to room temperature (approximately 20° C.). 623.9 g of a yellowish viscous liquid was obtained.

### Comparative Example 3

A 2 L glass flask with stirrer and a refluxing funnel was charged with 500 g polyethylenimine (PEI, Mw 5000 g/mol, amine number 17.7 mmol/g) and 935 g water was added (300 rpm) and nitrogen was purged 20 minutes while the mixture heated to 50° C. While the temperature was kept within 50-65° C., 135 g butylene oxide (BuO) was dosed over a period of 3 h. The mixture was stirred at 60° C. overnight. Then water was partially removed while the temperature was raised to 100-105° C. (30 minutes) and kept for 45 Minutes at 100° C. and then 40 mbar of vacuum was applied for 10 minutes. The obtained yellowish mixture was quenched with nitrogen and cooled to room temperature (approximately 20° C.). 1250 g of a yellowish viscous liquid was obtained that was diluted with 20 g water to achieve a 50% aqueous solution.

### Inventive Examples 1-13

### Example 1

A 5 L stainless steel reactor with stirrer was charged with 2700 g polyethyleneimine (PEI) (Mw 800 g/mol, amine number 18.2 mmol/g). The reactor was evacuated (60 mbar) and purged with nitrogen 3 times while increasing the temperature to 110° C. The reactor was pressurized to 2 bar and dosage of propylene oxide (PO) was initiated with 125 g PO within 5 minutes. While stirring at 150 rpm a further 720 g PO whilst dosed over a period of 3.5 hours. The temperature was raised to 120° C. and stirred for another 3 hours. Then the reactor was cooled to 60° C. and depressurized. Finally, the reactor was treated for 20 minutes at 100 mbar and purged with nitrogen. 3551 g of a slightly yellowish viscous liquid was obtained.

### Example 2

A 5 L stainless steel reactor with stirrer was charged with 2700 g PEI (Mw 800 g/mol, amine number 18.2 mmol/g). The reactor was evacuated (60 mbar) and purged with nitrogen 3 times while increasing the temperature to 100° C. The reactor was pressurized to 2 bar and dosage of propylene oxide was initiated with 112 g PO within 5 minutes. While stirring at 150 rpm a further 700 g PO was dosed over a period of 3 hours. The temperature was raised to 115° C. and stirred for another 3 hours. Then the reactor was cooled to 60° C. and depressurized. Finally, the reactor was treated for 20 minutes at 100 mbar and purged with nitrogen. 3409 g of a slightly yellowish viscous liquid was obtained.

### Example 3

A 5 L stainless steel reactor with stirrer was charged with 2700 g PEI (Mw 800 g/mol, amine number 18.2 mmol/g). The reactor was evacuated (60 mbar) and purged with nitrogen 3 times while increasing the temperature to 100° C. The reactor was pressurized to 2 bar and dosage of butylene oxide (BuO) was initiated with 125 g BuO within 5 minutes. While stirring at 150 rpm a further 760 g BuO was dosed over a period of 3 hours. The temperature was raised to 115° C. and stirred for another 4 hours. Then the reactor was cooled to 60° C. and depressurized. Finally, the reactor was treated for 20 minutes at 100 mbar and purged with nitrogen. 3581 g of a clear viscous liquid was obtained.

### Example 4

A 5 L stainless steel reactor with stirrer was charged with 2700 g PEI (Mw 1200 g/mol, amine number 17.9 mmol/g). The reactor was evacuated (60 mbar) and purged with nitrogen 3 times while increasing the temperature to 100° C. The reactor was pressurized to 2 bar and dosage of propylene oxide (PO) was initiated with 117 g PO within 5 minutes. While stirring at 150 rpm a further 640 g PO was dosed over a period of 3 hours. The temperature was raised to 115° C. and stirred for another 3 hours. Then the reactor was cooled to 60° C. and depressurized. Finally, the reactor was treated for 20 minutes at 100 mbar and purged with nitrogen. 3452 g of a slightly yellowish viscous liquid was obtained.

### Example 5

A 5 L stainless steel reactor with stirrer was charged with 2700 g PEI (Mw 1200 g/mol, amine number 17.9 mmol/g). The reactor was evacuated (60 mbar) and purged with nitrogen 3 times while increasing the temperature to 110° C. The reactor was pressurized to 2 bar and dosage of propylene oxide (PO) was initiated with 105 g PO within 5 minutes. While stirring at 150 rpm a further 400 g PO was dosed over a period of 2.5 hours. The temperature was raised to 115° C. and stirred for another 3 hours. Then the reactor was cooled to 60° C. and depressurized. Finally, the reactor was treated for 20 minutes at 100 mbar and purged with nitrogen. 3202 g of a slightly yellowish viscous liquid was obtained.

### Example 6

A 5 L stainless steel reactor with stirrer was charged with 2700 g PEI (Mw 1200 g/mol, amine number 17.9 mmol/g) followed by 470 g water. The reactor was evacuated (60 mbar) and purged with nitrogen 3 times while increasing the temperature to 100° C. The reactor was pressurized to 2 bar and dosage of propylene oxide (PO) was initiated with 117 g PO within 5 minutes. While stirring at 150 rpm a further 640 g PO was dosed over a period of 3.5 hours. The temperature was raised to 115° C. and stirred for another 3 hours. Then the reactor was cooled to 60° C. and depressurized. Finally, the reactor was treated for 10 minutes at 100 mbar and purged with nitrogen. 3913 g of a slightly yellowish liquid was obtained.

### Example 7

A 5 L stainless steel reactor with stirrer was charged with 2700 g PEI (Mw 5000 g/mol, amine number 17.7 mmol/g) followed by 385 g water. The reactor was evacuated (60 mbar) and purged with nitrogen 3 times while increasing the temperature to 100° C. The reactor was pressurized to 2 bar and dosage of butylene oxide (BuO) was initiated with 129 g BuO within 5 minutes. While stirring at 150 rpm a further 600 g BuO was dosed over a period of 3.5 hours. The temperature was raised to 120° C. and stirred for another 3 hours. Then the reactor was cooled to 60° C. and depressurized. Finally, the reactor was treated for 10 minutes at 100 mbar and purged with nitrogen. 3799 g of a clear liquid was obtained.

### Example 8

A 5 L stainless steel reactor with stirrer was charged with 2700 g PEI (Mw 5000 g/mol, amine number 17.7 mmol/g). The reactor evacuated (60 mbar) and purged with nitrogen 3 times while increasing the temperature to 100° C. The reactor was pressurized to 2 bar and dosage of propylene oxide (PO) was initiated with 105 g PO within 5 minutes. While stirring at 150 rpm a further 200 g PO was dosed over a period of 1.5 hours. As a next step 380 g butylene oxide (BuO) was dosed within 2 h, then the temperature was raised to 120° C. and stirred for another 3 hours. Then the reactor was cooled to 60° C. and depressurized. Finally, the reactor was treated for 20 minutes at 100 mbar and purged with nitrogen. 3380 g of a clear liquid was obtained.

### Example 9

A 5 L stainless steel reactor with stirrer was charged with 2700 g PEI (Mw 1200 g/mol, amine number 17.9 mmol/g). The reactor was evacuated (60 mbar) and purged with nitrogen 3 times while increasing the temperature to 100° C. The reactor was pressurized to 2 bar after 291 g of 1-decene oxide (DO) was added. Dosage of propylene oxide (PO) was executed within 3.5 hours (648 g). The temperature was raised to 115° C. and stirred for another 3 hours. Then the reactor was cooled to 60° C. and depressurized. Finally, the reactor was treated for 20 minutes at 100 mbar and purged with nitrogen. 3636 g of a slightly yellowish viscous liquid was obtained.

### Example 10

A 5 L stainless steel reactor with stirrer was charged with 2700 g PEI (Mw 1200 g/mol, amine number 17.9 mmol/g). The reactor was evacuated (60 mbar) and purged with nitrogen 3 times while increasing the temperature to 100° C. The reactor was pressurized to 2 bar after 201 g of 1-decenoxide (DO) was added. Dosage of butylene oxide (BuO) was executed within 3.5 hours (742 g). The temperature was raised to 115° C. and stirred for another 3 hours. Then the reactor was cooled to 60° C. and depressurized. Finally, the reactor was treated for 20 minutes at 100 mbar and purged with nitrogen. 3640 g of a clear viscous liquid was obtained.

### Example 11

A 5 L stainless steel reactor with stirrer was charged with 2500 g PEI (Mw 800 g/mol, amine number 18.2 mmol/g) followed by 590 g water. The reactor was evacuated (60 mbar) and purged with nitrogen 3 times while increasing the temperature to 100° C. The reactor was pressurized to 2 bar and dosage of butylene oxide (BuO) was initiated with 152 g BuO within 5 minutes. While stirring at 150 rpm a further 700 g BuO was dosed over a period of 3 hours. The temperature was raised to 120° C. and stirred for another 3.5 hours. Then the reactor was cooled to 60° C. and depressurized. Finally, the reactor was treated for 10 minutes at 100 mbar and purged with nitrogen. 3933 g of a clear liquid was obtained.

### Example 12

A 5 L stainless steel reactor with stirrer was charged with 2700 g PEI (Mw 5000 g/mol, amine number 17.7 mmol/g) and 375 g water. The reactor was evacuated (60 mbar) and purged with nitrogen 3 times while increasing the temperature to 100° C. The reactor was pressurized to 2 bar after 293 g of 1.2 dodecene oxide (DDO) was added. Dosage of propylene oxide (PO) was executed within 3.5 hours (462 g). The temperature was raised to 115° C. and stirred for another 3 hours. Then the reactor was cooled to 60° C. and depressurized. Finally, the reactor was treated for 10 minutes at 200 mbar and purged with nitrogen. 3826 g of a slightly yellowish viscous liquid was obtained.

### Example 13

A 2 L glass flask with stirrer and a refluxing funnel was charged with 500 g polyethylenimine (PEI, Mw 5000 g/mol, amine number 17.7 mmol/g) and 342 g water was added (300 rpm) and nitrogen was purged 20 minutes while the mixture heated to 50° C. While the temperature was kept within 50-65° C., 135 g butylene oxide (BuO) was dosed over a period of 3 h. The mixture was stirred at 60° C. overnight. Then water was partially removed while the temperature was raised to 100-105° C. (30 minutes) and kept for 30 Minutes at 100° C. and then 40 mbar of vacuum was applied for 10 minutes. The obtained yellowish mixture was quenched with nitrogen and cooled to room temperature (approximately 20° C.). 825 g of a yellowish viscous liquid was obtained that was diluted with 445 g water to achieve a 50% aqueous solution.

In the description of Comparative Examples 1-3 and Examples 1-13 the reference to amine number relates to the polyethyleneimine prior to alkoxylation.

TABLE 1

| | | | AO/NH | | | | | Amine- |
|---|---|---|---|---|---|---|---|---|
| | | | Sum AO | | | Residual | | number |
| | PEI - | | for | | | AO post | | mmol |
| Example | Mw | AO-type | mixtures | solvent | water | reaction | | NH/g |
| Comp. | 800 | PO | 0.3 | MeOH | — | 2600 | ppm | 12.3 |
| Ex 1 | | | | | | | | |
| Comp. | 1200 | BuO | 0.25 | MeOH/H₂O | 15% | 3200 | ppm | 12.9 |
| Ex 2 | | | | | | | | |
| Comp. | 5000 | BuO | 0.21 | H₂O | 60% | 380 | ppm | 13.2 |
| Ex 3 | | | | | | | | |
| Ex 1 | 800 | PO | 0.3 | — | — | 3 | ppm | 12.5 |
| Ex 2 | 800 | PC | 0.28 | — | — | 3 | ppm | 13.7 |
| Ex 3 | 800 | BuO | 0.25 | — | — | 5 | ppm | 13.2 |
| Ex 4 | 1200 | PO | 0.27 | — | — | 5 | ppm | 13.5 |
| Ex 5 | 1200 | PC | 0.18 | — | — | 3 | ppm | 14.7 |
| Ex 6 | 1200 | PO | 0.27 | H₂O | 12% | 9 | ppm | 13.3 |
| Ex 7 | 5000 | BuO | 0.21 | H₂O | 10% | 8 | ppm | 13.8 |
| Ex 8 | 5000 | PO, BuO | 0.22 | | — | | | 14.0 |
| | | 1/1 | | | | | | |
| Ex 9 | 1200 | PO, | 0.27 | — | — | 10 | ppm | 13.7 |
| | | decen- | | | | | | |
| | | oxide 6/1 | | | | | | |
| Ex 10 | 1200 | BuO, | 0.24 | — | — | 12 | ppm | 13.3 |
| | | decen- | | | | | | |
| | | oxide 8/1 | | | | | | |
| Ex 11 | 800 | BuO | 0.26 | H₂O | 15% | 14 | ppm | 13.2 |
| Ex 12 | 5000 | PO, | 0.20 | H₂O | 10% | 8 | ppm | 13.8 |
| | | Dodecen- | | | | | | |
| | | oxide 5/1 | | | | | | |
| Ex 13 | 5000 | BuO | 0.21 | H₂O | 35% | 90 | ppm | 13.3 |

In Table 1 the reference to amine number refers to the amine number of the alkoxylated polyethyleneimine. The reference to PO means propylene oxide and the reference to BuO means butylene oxide.

The alkoxylated polyethyleneimines prepared in Examples 1 to 13 and Comparative Examples 1 to 3 were evaluated using equilibria and absorption at 40° C. of a 15% CO₂ gas mixture containing 5% O₂ and 80% N₂. The results are presented in Table 2.

Determining the equilibrium loading with CO₂

The equilibrium loading is determined in a bubble column reactor as described in BRECHTEL, K. Einfluss der Molekülstruktur auf die-Abtrennung mit wässrigen Aminlösungen aus Rauchgasen fossil befeuerter Kraftwerke. Dissertation/PhD, Universität Stuttgart, 2011; A. Schäffer, Amine und Aminmischungen zur-Absorption aus Kraftwerksrauchgasen und ihr Energiebedarf zur Regeneration Dissertation/PhD, Universität Stuttgart, 2013].

Therein, 0.15 kg of the sample is diluted with 0.15 kg water to yield a 50% aqueous solution. The sample is heated in a water bath on an adjustable heating plate and exposed to a stream of 21/min of synthetic flue gas with the composition 15% by volume C=2, 5%=2 and 80% N₂. The flue gas is injected into the sample using a mass flow controller via a glass frit (pore size 1), so that good mixing and a large mass transfer area are achieved. The exiting (surplus) low-CO₂ gas flow is fed to an infrared gas analyzer via a return flow and sample gas cooler. The reflux cooler condenses the evaporated water or solvent and feeds it back into the sample. The gas composition is continuously measured with the infrared gas analyzer and recorded via a computer interface.

The sample of mass [kg] is then in equilibrium with the CO₂ concentration in the flue gas or with the prevailing CO₂ partial pressure. The CO₂ volume absorbed by the solvent [m] results from integral formation over time [min]. The entering flue gas volume flow [l/min] is constant. The equilibrium loading] is then calculated in terms of weight % CO₂ with respect to the mass of the 50% sample solutions. For this purpose, the equilibrium loadings are determined at a temperature of 50° C.

All of the carbon dioxide absorbents employed (alkoxylated polyethyleneimine, polyethyleneimine or ethanolamine) are employed as 50% by weight aqueous solutions in the testwork.

The rotational speed (i.e. adsorption/desorption cycle) importantly results from the uptake/adsorption velocity and the desorption velocity.

TABLE 2

| | | CO₂ uptake using | |
|---|---|---|---|
| | | an aqueous solution | |
| | | of the alkoxylated | Time to achieve |
| | Absorbent | PEI (50% by weight) | 90% of the total |
| Example | Employed | Wt % | uptake [min] |
| Comparative | Alkoxylated PEI | 7.0 | 18 |
| Example 4 | from Comparative | | |
| | Example 1 | | |
| Comparative | Alkoxylated PEI | 7.4 | 16 |
| Example 5 | from Comparative | | |
| | Example 2 | | |
| Comparative | Alkoxylated PEI | 7.75 | 15 |
| Example 6 | from Comparative | | |
| | Example 3 | | |
| Comparative | Polyethyleneimine, | 14.1 | 25 |
| Example 7 | Mn 800 g/dl | | |
| Comparative | Ethanolamine | 16.5 | 37 |
| Example 8 | | | |
| Comparative | Polyethyleneimine, | 15.7 | 27.5 |
| Example 9 | Mn 5000 g/dl | | |
| Example 14 | Alkoxylated PEI | 8.8 | 12 |
| | from Example 1 | | |
| Example 15 | Alkoxylated PEI | 9.15 | 10.5 |
| | from Example 2 | | |
| Example 16 | Alkoxylated PEI | 9.20 | 8.3 |
| | from Example 3 | | |
| Example 17 | Alkoxylated PEI | 8.75 | 9 |
| | from Example 4 | | |
| Example 18 | Alkoxylated PEI | 9.28 | 8 |
| | from Example 5 | | |
| Example 19 | Alkoxylated PEI | 8.6 | 9.5 |
| | from Example 6 | | |
| Example 20 | Alkoxylated PEI | 9.15 | 9 |
| | from Example 7 | | |
| Example 21 | Alkoxylated PEI | 9.35 | 8.3 |
| | from Example 8 | | |
| Example 22 | Alkoxylated PEI | 9.20 | 10 |
| | from Example 9 | | |
| Example 23 | Alkoxylated PEI | 9.45 | 8.5 |
| | from Example 10 | | |
| Example 24 | Alkoxylated PEI | 9.05 | 10.5 |
| | from Example 11 | | |
| Example 25 | Alkoxylated PEI | 9.50 | 9.5 |
| | from Example 12 | | |
| Example 26 | Alkoxylated PEI | 8.2 | 11 |
| | from Example 13 | | |

The inventive alkoxylated polyethyleneimines demonstrate a significantly improved ability to absorb carbon dioxide by comparison to the comparative alkoxylated polyethyleneimines and the non-alkoxylated amines comprising monoethanolamine (MEA) (ethoxylated ammonia). Although the non-alkoxylated amines and ethanolamine show a higher total CO₂ absorption capacity, the circular speed (i.e. rotational speed or speed of the absorption/desorption cycle) and the absorption volume per time is much lower.

1. A method of using a composition comprising alkoxylated polyalkyleneimine, the method comprising using the composition for capturing gases with a pKa greater than 5, from a gas or mixture of gases, the composition being obtainable obtained by a process comprising the steps:
(a) providing a reaction mixture comprising
(i) a polyalkyleneimine; and
(ii) an alkylene oxide;
(b) carrying out a reaction between the (i) polyalkyleneimine and the (ii) alkylene oxide at a temperature of at least 50° C.; and
(c) optionally diluting the product of step (b),
wherein the mole ratio of alkylene oxide to NH of the polyalkyleneimine in the reaction mixture is from 0.1 to 0.35,
and wherein the reaction mixture comprises <55% water by weight based on the weight of the reaction mixture and the reaction mixture comprises less than 5% of a polar organic solvent by weight based on the weight of the reaction mixture.

2. The method of using the composition according to claim 1, wherein the alkoxylated polyalkyleneimine is an alkoxylated polyethyleneimine and the (i) polyalkyleneimine in step (a) is a polyethyleneimine.

3. The method of using the composition according to claim 1, wherein
(i) the reaction mixture comprises <20% water by weight based on the weight of the reaction mixture; and/or
(ii) the reaction mixture is free from any polar organic solvent; and/or
(iii) the reaction mixture is solvent free and contains water in an amount only as a reactant, suitably up to 1 mole of water per mole of NH groups of the polyalkyleneimine.

4. (canceled)

5. (canceled)

6. The method of using the composition according to claim 3, wherein in step (a) the (i) polyalkyleneimine, is provided at a temperature of at least 50° C., and the (ii) alkylene oxide is provided at a temperature of at least 50° C., and combined with the (i) polyalkyleneimine, preferably polyethyleneimine, to form the reaction mixture.

7. The method of using the composition according to claim 1, wherein the reaction in step (b) is carried out at a temperature of from 60° C. to 140° C.

8. The use method of using the composition according to claim 1, wherein the reaction in step (b) is carried out at a pressure greater than 1.25 bar.

9. The method of using the composition according to claim 8, wherein the dilution step (c) is carried out after the reaction mixture has been de-pressurised.

10. The use method of using the composition according to claim 1, wherein the weight ratio of alkylene oxide to NH of the polyalkyleneimine in the reaction mixture is from 0.15 to 0.32.

11. (canceled)

12. The method of using the composition according to claim 1, wherein (i) the polyalkyleneimine the reaction mixture has a weight average molecular weight (Mw) of from 300 to 10,000 g/mol; and/or
(ii) the polyalkyleneimine in the reaction mixture is branched.

13. (canceled)

14. The method of using the composition according to claim 1, wherein the alkoxylated polyalkyleneimine has a molar ratio of OH/NH of from 0.20 to 0.35.

15. (canceled)

16. The method of using the composition according to claim 1, wherein the alkoxylated polyalkyleneimine is incorporated into a formulation for direct capturing of carbon dioxide.

17. The method of using the composition according to claim 1, wherein the gas or mixture of gases is either atmospheric air or exhaust fumes.

18. A process of preparing a composition comprising an alkoxylated polyalkyleneimine obtained by the process comprising the steps:
(a) providing a reaction mixture comprising
(i) a polyalkyleneimine; and
(ii) an alkylene oxide, the alkylene oxide comprising propylene oxide and/or butylene oxide;
(b) carrying out a reaction between the (i) polyalkyleneimine and the (ii) alkylene oxide at a temperature of at least 50° C.,
(c) optionally diluting product of step (b),
wherein the mole ratio of alkylene oxide to NH of the polyalkyleneimine in the reaction mixture is from 0.1 to 0.35,
and wherein the reaction mixture comprises <55% water by weight based on the weight of the reaction mixture and the reaction mixture comprises less than 5% of a polar organic solvent, by weight based on the weight of the reaction mixture.

19. The process according to claim 18, wherein the process comprises any of the features of claim 2.

20. A composition comprising an alkoxylated polyalkyleneimine, wherein the composition is obtained by the process of claim 18.

21. (canceled)
